(19) United States
(12) Patent Application Publication
(10) Pub. No.: US 2009/0228815 A1
(43) Pub. Date: Sep. 10, 2009

(54) TECHNIQUES FOR MANAGING INTERFACES BASED ON USER CIRCUMSTANCES

(75) Inventors: Richard R. Dellinger, San Jose, CA (US); Jeffrey A. Finkelstein, San Francisco, CA (US)

Correspondence Address: KACVINSKY LLC;4500 BROOKTREE ROAD, SUITE 102, WEXFORD, PA, 15090, US

(73) Assignee: PALM, INC., SUNNYVALE, CA (US)

(21) Appl. No.: 12/045,654

(22) Filed: Mar. 10, 2008

(51) Int. Cl. G06F 3/048

(52) U.S. Cl. 715/764

(57) ABSTRACT

An apparatus may include a user interface and a profile management module. The user interface receives a user-selected operational mode. This operational mode may be selected from a personal mode and a work mode. The profile management module causes information to be presented to the user through the user interface in accordance with the user-selected operational mode.

### BACKGROUND

Mobile computing devices, such as smart phones, may provide various processing capabilities. For example, mobile devices may provide personal digital assistant (PDA) features, including word processing, spreadsheets, and synchronization of information with a desktop computer. In addition, such devices may have wireless communications capabilities to provide features, such as mobile telephony, mobile e-mail access, web browsing, reception of content (e.g., video and audio), and so forth.

Also, such devices may maintain contact-related information. For example, personal information management applications may allow users to store and access information for individuals, businesses, schools, and other entities. This information may include physical addresses, telephone numbers, e-mail addresses, as well as other forms of information.

In addition, such devices may allow users to store and access tasks. As tasks become due, users may be provided with corresponding notifications.

Moreover, such devices provide users with the capability to generate and maintain schedules. For example, personal information management applications allow users to schedule appointments. Such appointments may involve a single participant or multiple participants (e.g., users of multiple devices). Also, as an appointment's scheduled time approaches, its participants may receive reminder notifications for the appointment.

With converged handheld devices, users can be perpetually connected to work e-mail and tasks. In fact, a substantial amount of time and energy has been spent to provide solutions that ensure users have access to their work-related data when they are away from their desks.

However, having such access can be intrusive during times designated for personal activities (e.g., during evenings, holidays, etc.). Moreover, some device users are seeing their personal relationships suffer because of an inability to separate work time and personal time. For instance, it is common to be confronted with unread e-mail messages, voice mails, and upcoming tasks as soon as a user turns on his device. Many users find it difficult to ignore acting on these work-related items once they are alerted to them. As a result, some users are rejecting the always connected lifestyle.

Accordingly, techniques may be needed to enhance separation between personal lives and work lives.

### BRIEF DESCRIPTION OF THE DRAWINGS

FIG. 1 illustrates an exemplary apparatus.

FIG. 2 is a diagram of exemplary user profiles.

FIG. 3 illustrates an embodiment of a logic flow.

FIGS. 4A and 4B are diagrams of exemplary display interfaces.

FIG. 5 is a view of an exemplary handheld device.

### DETAILED DESCRIPTION

Various embodiments may be generally directed to techniques for managing interfaces. For example, in embodiments, an apparatus may include a user interface and a profile management module. The user interface receives a user-selected operational mode. This operational mode may be selected from a personal mode and a work mode. The profile management module causes information to be presented to the user through the user interface in accordance with the user-selected operational mode.

Embodiments may include one or more elements. An element may comprise any structure arranged to perform certain operations. Each element may be implemented as hardware, software, or any combination thereof, as desired for a given set of design parameters or performance constraints. Although embodiments may be described having particular elements in certain arrangements by way of example, embodiments may include other combinations of elements, as well as alternate arrangements.

It is worthy to note that any reference to “one embodiment” or “an embodiment” means that a particular feature, structure, or characteristic described in connection with the embodiment is included in at least one embodiment. The appearances of the phrases “in one embodiment” and “in an embodiment” in various places in the specification are not necessarily all referring to the same embodiment.

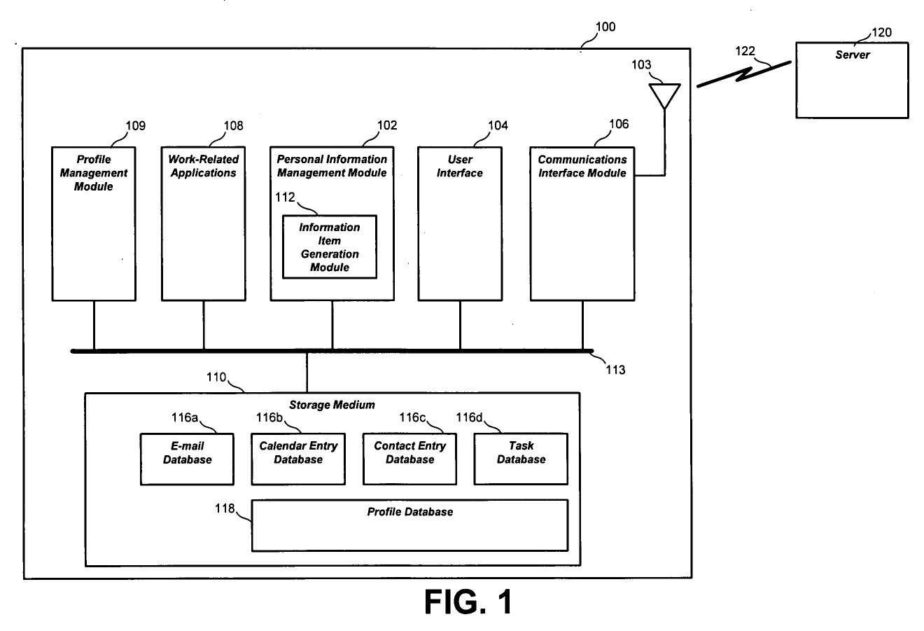

FIG. 1 illustrates an exemplary apparatus 100 that may comprise various elements. For instance, FIG. 1 shows that apparatus 100 may include a personal information management module 102, a user interface 104, a communications interface module 106, work-related applications 108, a profile management module 109, a storage medium 110, and an interconnection medium 113. These elements may be implemented in hardware, software, firmware, or any combination thereof.

The elements of apparatus 100 may be included in various devices. Examples of such devices include mobile phones, wireless PDAs, smartphones, notebook computers, and tablet computers. However, embodiments are not limited to these examples.

Within apparatus 100, personal information management module 102 may perform operations involving the generation, communications, output (e.g., display), and storage of various information items. Exemplary information items include e-mails, tasks, contact entries, and/or calendar entries. However, other information may be employed. These information items may be labeled as either personal or work-related.

Contact entries may include fields that provide information regarding an individual, organization, or other entity. For example, a contact entry may include a physical address (e.g., a street address) field, a telephone number field, a fax number field, an e-mail address field, and/or a descriptive data field. However, contact entries are not limited to these examples. In embodiments, contact entries may be labeled as either personal or work-related.

Tasks may include descriptive information (e.g., task names) and due dates. Moreover, tasks may assigned to various categories. In embodiments, tasks may be assigned to various categories. Such categories may be, for example, work-related or personal in nature.

Calendar entries may include various data fields. For example, a calendar entry may include a title, start and end times, a duration, one or more participants, a location, user generated text, and so forth. Also, in embodiments, calendar entries may be labeled as either work-related or personal.

As shown in FIG. 1, personal information management module 102 may include an information item generation module 112. Information item generation module 112 generates information items handled by personal information management module 102, such as e-mails, tasks, contact entries, and calendar entries (e.g., appointments). Such generation may be initiated by a user of apparatus 100. More particularly, a user may perform operations (e.g., through user interface 104) that create such information items. These operations may include the user commencing a generation process, the user entering data associated with the information item, and the user initiating an action for the information item. Such actions may include sending an e-mail, saving a task, saving a contact entry, and/or saving a calendar entry. The embodiments, however, are not limited to these exemplary actions.

Additionally or alternatively, the generation of such information items may be initiated through messages originated by remote devices. For instance, apparatus 100 may receive a proposed contact entry message, a proposed task message, and/or a proposed calendar entry message. Upon receipt, the user (through user interface 104) may view proposed information items conveyed by such messages, and may determine whether to store them.

As described above, personal information management module 102 may perform operations involving the display of information items to a user. The displaying of such information may be through user interface 104. In embodiments, information may be presented (e.g., displayed) to a user in accordance with particular operational modes, such as a work mode and a personal mode. Details regarding such modes are provided below.

As shown in FIG. 1, communications interface module 106 is coupled to personal information management module 102. Communications interface module 106 provides for the exchange of information with other devices. Such information may include, for example, e-mails. Also, such information may include messages providing proposed information items received from remote devices. These messages are provided as examples and not as limitations. Therefore, communications interface module 106 may provide for the exchange of other information.

For purposes of illustration, FIG. 1 shows communications interface module 106 (through an antenna 103) exchanging information with a server 120 (e.g., an e-mail server). FIG. 1 further shows that this exchange occurs across a link 122 of a wireless network.

Exemplary wireless networks include wireless local area networks (WLANs), such as IEEE 802.11 WiFi links, as well as wireless metropolitan area networks (WMANs), such as IEEE 802.16 WiMax links and IEEE 802.16e WiBro links. Also, wireless networks may include personal area networks (PAN) such as Bluetooth. Further, wireless networks may include radio frequency identification (RFID) links. Moreover, such wireless networks may include cellular and satellite communications systems. However, other types of wireless networks may be employed.

Additionally or alternatively, communications interface module 106 may communicate with devices across wired networks. Exemplary wired networks include, for example, local area networks (LANs), such as IEEE 802.3 Ethernet networks, and/or wired telephony networks. Embodiments, however, are not limited to these examples.

To provide such features, communications interface module 106 may include electronics, such as modulators, demodulators, amplifiers, filters, and/or antennas. Furthermore, communications interface module 106 may include components and/or functionality to operate according to one or more protocol layers. Such protocol layers may provide features, such as packet encapsulation/decapsulation, error correction encoding/decoding, signaling, link protocols, and/or media access protocols. Embodiments, however, may include other components and/or functionality. These features may be implemented in hardware, software, firmware, or any combination thereof.

User interface 104 facilitates user interaction. This interaction may involve the input of information from a user and/or the output of information to a user. For example, as described herein, user interface 104 may provide for the generation of contact entries, the viewing of contact entry information, and so forth. Accordingly, user interface 104 may include one or more devices, such as a keyboard (e.g., a full QWERTY keyboard), a keypad, a display (e.g., a touch screen), a microphone, and/or an audio speaker. The embodiments, however, are not limited to these examples.

Work-related applications 108 provide users with the ability to perform business tasks that are typically associated with a work context. Examples of such applications include word processing applications (e.g., Microsoft Word), spreadsheet applications (e.g., Microsoft Excel), and presentation applications (e.g., Microsoft PowerPoint). Embodiments, however, are not limited to these applications.

Profile management module 109 establishes operational characteristics of apparatus 100. Such characteristics include, for example, the manner in which information is presented to a user. Accordingly, profile management module 109 may establish such characteristics through directives. These directives may be sent to various elements of apparatus 100. For example, profile management module 109 may direct personal information management module to display information in a particular manner. Likewise, profile management module 109 may direct work-related applications 108 to be opened, shut-down, minimize, or perform other operations.

In embodiments, profile management module 109 establishes operational characteristics based on a current operational mode and user profile data associated with the current operational mode. Such user profile data may be stored, for example, in storage medium 110.

Interconnection medium 113 provides for couplings among elements of apparatus 1 00. Thus, interconnection medium 113 may include, for example, one or more bus interfaces. Exemplary interfaces include Universal Serial Bus (USB) interfaces, as well as various computer system bus interfaces. Additionally or alternatively, interconnection medium 113 may include one or more point-to-point connections (e.g., parallel interfaces, serial interfaces, etc.) between various element pairings. Such connections may comprise one or more signal lines. Additionally or alternatively, interconnection medium 113 may include non-physical aspects. More particularly, interconnectivity provided by interconnection medium 113 may be implemented through messages passed between processes or software modules.

Storage medium 110 may be implemented using any machine-readable or computer-readable media capable of storing data, including both volatile and non-volatile memory. For example, such storage media may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information.

It is worthy to note that some portion or all of storage medium 110 may be included in other elements of apparatus 100. For instance, some or all of storage medium 110 may be included on a same integrated circuit or chip with elements of apparatus 100. Alternatively, some portion or all of storage medium 110 may be disposed on an integrated circuit or other medium (e.g., a hard disk drive) that is external. The embodiments are not limited in this context.

As described herein, information items may be saved upon their generation or receipt from other devices. For example, e-mails may be saved in an e-mail database 116a, calendar entries may be saved in a calendar entry database 116b, contact entries may be saved in a contact entry database 116c, and tasks may be saved in a task database 116d. These databases are shown as examples, and not limitations. Therefore, other databases or storage arrangements may be employed. FIG. 1 shows that databases 116a-d may be included in storage medium 110. These databases may be implemented in various ways (e.g., as relational databases, as object oriented databases, with various data structures/objects, etc.).

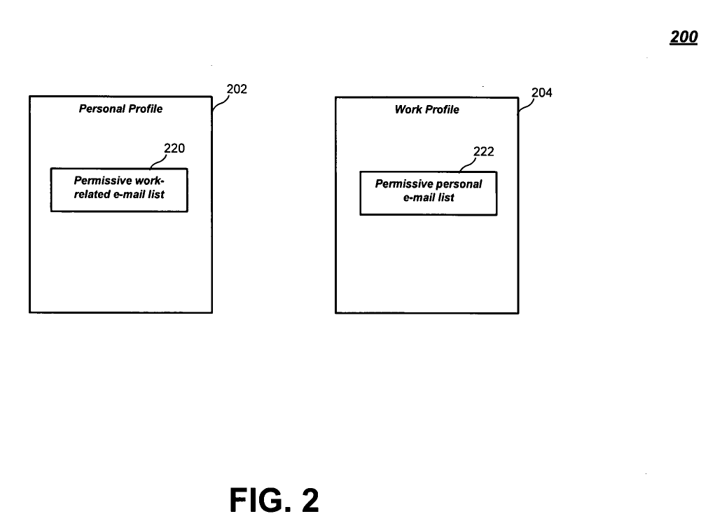

As shown in FIG. 1, storage medium 110 includes a profile database 118. This database may specify certain operational characteristics (e.g., profiles) for certain operational modes. For example, profile database 118 may provide a profile for a work mode, and a profile for a personal mode. Based on these profiles, profile management module 109 may establish operational characteristics of apparatus 100. Details regarding an exemplary implementation of profile database 118 are provided below with reference to FIG. 2.

In addition to providing databases 116a-d and 118, storage medium 110 may store information such as application documents, media items (e.g., image files, audio files, video files, etc.), and so forth. Such information (as well as the information within databases 116a-d and 118) may be stored in various encoded or unencoded formats.

Although FIG. 1 shows the local storage (e.g. within storage medium 110) of information, embodiments may store some or all of such information items remotely. For instance, information items handled by personal information management module 102 may be uploaded (via communications interface module 106) and stored by a remote device (such as a server). Thus, databases 116a-d and 118 (as well as other information storage) may be implemented locally and/or remotely.

As described above, the elements of FIG. 1 may be implemented in hardware, software, firmware, or any combination thereof. Thus, implementations may include one or more processors (not shown) that execute instructions or control logic (e.g., software) stored in a storage medium (e.g., memory) such as storage medium 110. The embodiments, however, are not limited to such implementations. The control logic or instructions may provide features of one or more elements of apparatus 100.

In general operation, apparatus 100 may perform various operations associated with personal information management module 102 and various applications (e.g., work-related applications 108). However, these operations and the manner in which information is presented to the user are determined by a current operational mode. Examples of such modes include a personal mode and a work mode. In the personal mode, the output of work-related information may be suppressed. In contrast, work-related information is emphasized in the work mode. However, personal information may be de-emphasized in this mode. These modes are provided as examples. Accordingly, embodiments, are not limited to these modes.

FIG. 2 is a diagram 200 showing exemplary profile database entries. In particular, FIG. 2 shows a personal profile 202 and a work profile 204. Each profile includes information that determines device operation in its corresponding modes.

For instance, personal profile 202 includes a permissive work-related e-mail list 220. This list indicates work-related individuals (or entities) whose e-mails may be displayed during personal mode operations. Similarly, work profile 204 includes a permissive personal e-mail list 222. This list indicates personal individuals (or entities) whose e-mails may be displayed during work mode operations. Lists 220 and 222 may each indicate individuals by their e-mail addresses. However, other types of indicators may be employed.

The profiles of FIG. 2 are provided as examples, and not as limitations. Accordingly, embodiments may employ profiles containing other information.

Embodiments may be further described with reference to the following figures and accompanying examples. Some of the figures may include a logic flow. Although such figures presented herein may include a particular logic flow, it can be appreciated that the logic flow merely provides an example of how the general functionality described herein may be implemented. Further, the given logic flow does not necessarily have to be executed in the order presented, unless otherwise indicated. In addition, the given logic flow may be implemented by a hardware element, a software element executed by a processor, or any combination thereof.

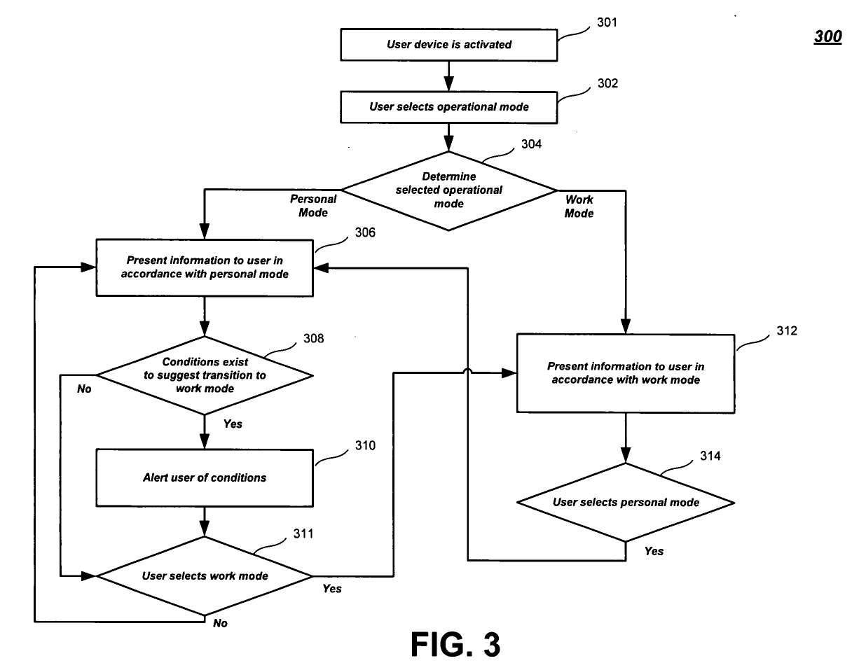

FIG. 3 illustrates one embodiment of a logic flow. In particular, FIG. 3 illustrates a logic flow 300, which may be representative of the operations executed by one or more embodiments described herein. Although FIG. 3 shows a particular sequence, other sequences may be employed. Also, the depicted operations may be performed in various parallel and/or sequential combinations.

The logic flow of FIG. 3 is described with reference to a user device. This device may include the features described above with reference to FIG. 1. However, embodiments are not limited to these device features.

As shown in FIG. 3, logic flow 300 includes a block 301, in which the user device is activated. This may comprise applying operational power to the device and entering one or more personal identification numbers (PINs), passcodes, and/or passwords. Then, at a block 302, the device's user selects from various operational modes. For instance, the user may select from a personal mode and a work mode. Embodiments, however, are not limited to this combination of available modes.

The user device determines the selected mode at a block 304. As shown in FIG. 3, if the personal mode is selected, operation proceeds to a block 306. However, if the work mode is selected, then the flow proceeds to a block 312.

At block 306, information is presented to the user through its user interface in accordance with the personal mode. In the context of FIG. 1, this presentation of information may be through user interface 104. In the personal mode, the presentation of work-related information is de-emphasized. Further, in the personal mode, the user is presented with an uncluttered user interface that appears clean and is easy to use. Further, the user may be presented with personal theme(s) and personal connections in the personal mode. Examples of such themes and connections include displayed images of personal acquaintances, family, and/or other user-selected individuals.

Various techniques involving the presentation of information to the user may be employed in the personal mode. For instance, restrictions may be imposed in the displaying of unread e-mail. As an example, embodiments may preclude the displaying of unread e-mail during personal mode operations. Alternatively, embodiments may allow the display of a predetermined number of the most recently received unread e-mail(s) during personal mode operations. Thus, personal mode operations may advantageously prevent the user from being inundated with unread e-mail.

Other techniques regarding the presentation of e-mails may be employed during personal mode operations. For instance unread e-mails from user-designated individuals or entities may be displayed in the personal mode. Also, embodiments may limit the number of such e-mails that are displayed. For example, embodiments may limit the display to a predetermined number of the most recently received e-mails from designated individuals or entities. However, further embodiments may refrain from imposing such numerical limits.

Also, during personal mode operations, restrictions may be imposed in the displaying of upcoming tasks. For example, in embodiments, no upcoming work-related tasks are displayed during personal mode operations. Alternatively, a predetermined number of upcoming work-related tasks may be displayed during personal mode operations. As a further alternative, embodiments may refrain from displaying any tasks to the user during personal mode operations.

Further, during personal mode operations, restrictions may be imposed in the displaying of upcoming calendar events. In embodiments, no upcoming work-related calendar events are displayed during personal mode operations. Alternatively, a predetermined number of upcoming work-related calendar events may be displayed during personal mode operations.

Alternatively or additionally, embodiments may restrict the displaying of personal calendar events. For instance, embodiments may refrain from displaying any upcoming personal calendar events during personal mode operations. Also, embodiments may allow up to a predetermined number of upcoming personal calendar events to be displayed during personal mode operations.

Moreover, during personal mode operations, the visibility of traditionally work-related applications may be reduced or eliminated from visibility. Examples of such work-related applications include (but are not limited to) Microsoft Word, Microsoft Excel, and Microsoft PowerPoint.

The techniques listed above are provided as examples and not limitations. Therefore, other techniques (as well as the techniques listed above) may be employed in any combination.

At a block 308, the device determines whether condition(s) exist that would suggest a transition into work mode. Examples of such conditions include (but are not limited to) the approaching of one or more work-related calendar events, and/or an increase in the number of incoming work-related e-mails. If such condition(s) exist, then the user is alerted to these conditions (e.g., through the device's user interface) at a block 310. Otherwise, the flow proceeds from block 308 to block 311.

FIG. 3 shows that at block 311, the user may decide to change the operational mode from personal mode operations to work mode operations. If so, then the flow proceed to block 312.

At block 312, the device presents information to the user through its user interface in accordance with the work mode. In the work mode, the presentation of work-related information is emphasized. Therefore, the display of unread e-mails, upcoming tasks, and upcoming calendar events are not limited in the manner of the personal mode. Moreover, the visibility of traditional work-related applications are not suppressed as in the manner of the personal mode.

FIG. 3 further shows a block 314. This block allows a transition from the work mode to the personal mode based on a user selection (e.g., through the device's user interface). Thus, if the personal mode is selected, operation proceeds to block 306.

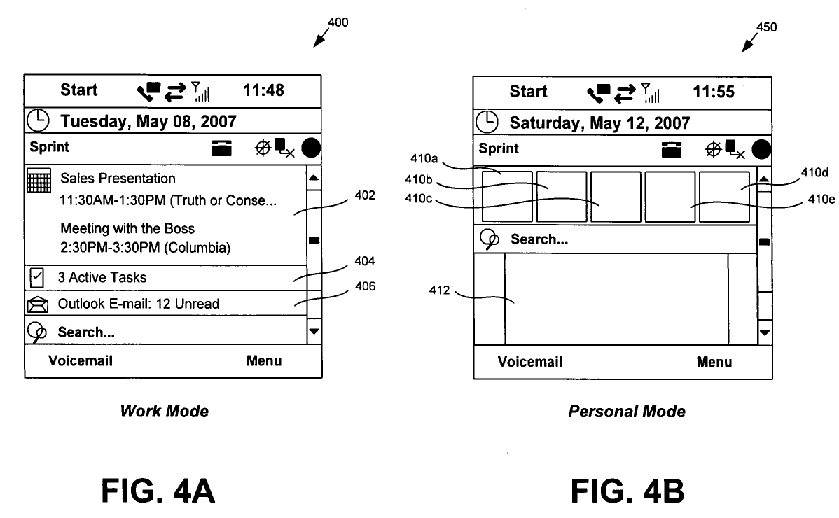

FIGS. 4A and 4B are diagrams of exemplary display interfaces. For instance, FIG. 4A shows a display interface 400 that present information in accordance with a work mode. In contrast, FIG. 4B shows a display interface 450 that presents information in accordance with a personal mode.

As shown in FIG. 4A, calendar entries, tasks, and unread e-mail are clearly emphasized in their presentation. For instance, FIG. 4A shows a display panel 402 for upcoming calendar appointments, a display panel 404 for active or upcoming tasks, and a display panel 406 for unread e-mail.

In contrast, FIG. 4B shows no e-mail, tasks, or calendar entries. In addition, FIG. 4B shows pictures of personal contacts and images. Instead, FIG. 4B shows display panels 410a-e for displaying images of (or associated with) individuals or entities of a personal nature. Also, FIG. 4B shows a panel 412 for the display of content, such as an image, that is personal in nature.

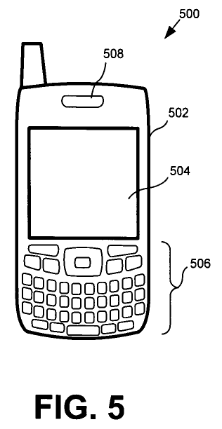

FIG. 5 provides a view of an exemplary handheld device 500, which may include apparatus 100 of FIG. 1. In particular, FIG. 5 is a front view that shows device 500 having a case 502. Further, this view shows device 500 having a display (e.g., a touch screen) 504, a keypad 506 (including, for example, a QWERTY keyboard, navigation buttons, and so forth), and a speaker 508. With reference to FIG. 1, these components may be included in user interface 104. The view of FIG. 5 is provided for the purposes of illustration, and not limitation. Thus, embodiments may include further devices, handheld or otherwise.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus, comprising:
a user interface to receive a user-selected operational mode, the user-selected operational mode from a personal mode and a work mode; and
a profile management module to cause information to be presented to the user through the user interface in accordance with the user-selected operational mode.

2. The apparatus of claim 1, wherein the profile management module is to restrict the display of unread e-mail when the user-selected operational mode is the personal mode.

3. The apparatus of claim 1, wherein the profile management module is to restrict the display of tasks when the user-selected operational mode is the personal mode.

4. The apparatus of claim 1, wherein the profile management module is to restrict the display of calendar entries when the user-selected operational mode is the personal mode.

5. The apparatus of claim 1, wherein the profile management module is to limit visibility of work-related applications when the user-selected operational mode is the personal mode.

6. The apparatus of claim 1, further comprising:
a storage medium to store profile information corresponding to the personal mode, and profile information corresponding to the work mode.

7. The apparatus of claim 1:
wherein, when the user-selected mode is the personal mode, the profile management module is to alert the user of increased numbers of incoming work-related e-mails.

8. The apparatus of claim 1, wherein:
when the user-selected mode is the personal mode, the profile management module is to alert the user of upcoming work-related calendar events.

9. A method, comprising:
receiving a user selection of an operational mode, wherein the user-selected operational mode is from a personal mode and a work mode;
presenting information to the user in accordance with the user-selected operational mode.

10. The method of claim 9, wherein said presenting comprises restricting the display of unread e-mail when the user-selected operational mode is the personal mode.

11. The method of claim 9, wherein said presenting comprises restricting the display of tasks when the user-selected operational mode is the personal mode.

12. The method of claim 9, wherein said presenting comprises restricting the display of calendar entries when the user-selected operational mode is the personal mode.

13. The method of claim 9, wherein said presenting comprises limiting visibility of work-related applications when the user-selected operational mode is the personal mode.

14. A method, comprising:
receiving a user selection of an operational mode;
presenting information to the user in accordance with the user-selected operational mode;
wherein said presenting comprises de-emphasizing work-related information when the user-selected operational mode is a personal mode.

15. The method of claim 14, wherein said presenting comprises restricting the display of unread e-mail when the user-selected operational mode is the personal mode.

16. The method of claim 14, wherein said presenting comprises restricting the display of tasks when the user-selected operational mode is the personal mode.

17. The method of claim 14, wherein said presenting comprises restricting the display of calendar entries when the user-selected operational mode is the personal mode.

18. An apparatus, comprising:
a user interface to receive a user-selected operational mode; and
a profile management module to cause information to be presented to the user through the user interface in accordance with the user-selected operational mode;
wherein the profile management module is to de-emphasize work-related information when the user-selected operational mode is a personal mode.

19. The apparatus of claim 17, further comprising:
a storage medium to store profile information corresponding to the personal mode.

20. An article comprising a computer-readable storage medium containing instructions that if executed enable a system to:
receive a user selection of an operational mode;
present information to the user in accordance with the user-selected operational mode;
wherein said presenting comprises de-emphasizing work-related information when the user-selected operational mode is a personal mode.
